(19) United States
(12) Patent Application Publication
(10) Pub. No.: US 2005/0052704 A1
(43) Pub. Date: Mar. 10, 2005

(54) Image data compensation scanner, medium, and method

(75) Inventor: Yang-moon Kim, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 10/899,063

(22) Filed: Jul. 27, 2004

(30) Foreign Application Priority Data
Aug. 14, 2003 (KR) 2003-56389

(51) Int. Cl. H04N 1/40; H04N 1/409

(52) U.S. Cl. 358/3.26; 358/406

(57) ABSTRACT

An image data compensation method and apparatus, with the method including calculating a distance between a first reference line adjacent to a pattern and the pattern, calculating a distance between a second reference line adjacent to the pattern and perpendicular to the first reference line and the pattern, and calculating a difference between the predetermined coordinate value and the distances calculated, based on the first and second reference lines. Such an image data compensation method can compensate for image data errors due to mechanical tolerances each scanner has at a low cost when the scanner scans documents.

### CROSS-REFERENCE TO RELATED APPLICATIONS

This application claims the priority benefit of Korean Patent Application No. 2003-56389, filed on Aug. 14, 2003, in the Korean Intellectual Property Office, the disclosure of which is incorporated herein by reference.

### BACKGROUND OF THE INVENTION

1. Field of the Invention

The present invention relates to a scanner, and more particularly, to an image data compensation method for scanners capable of improving scan accuracy at a low cost.

2. Description of the Related Art

In general, a scanner, e.g., an optical scanner, emits and reflects light onto and from a medium, e.g., a paper document, converts the reflected light into an electric signal through a sensor such as the Charge Coupled Device (CCD) or the Contact Image Sensor (CIS), and stores the electric signal in a storage medium such as a hard disc drive (HDD) provided in a computer system. In general, the scanner is provided with a flat bed for placing a document thereon and an optical mechanism for emitting light onto the document placed on the flat bed. The optical mechanism is designed to move back and forth while emitting light on an area corresponding to a document size in order to emit light over the entire document area.

FIG. 1 schematically illustrates conventional connections between a computer system and a scanner.

As illustrated in FIG. 1, a conventional scanner 20 can be connected to a computer system. 10. When a scanning command is applied from an application program provided in the computer system, the scanner 20 performs scanning operations in response to the scanning command and transfers to the computer system 10 a bitmap image obtained through the scanning operations. The application program provided in the computer system 10 generates a command controlling whether all or a part of the document loaded on the scanner 20 can be scanned, and a driver program provided in the computer system interprets the command and drives the scanner 20. The driven scanner 20 produces a bitmap image for an area chosen by the application program, and transfers the bitmap image to the computer system 10.

FIG. 2 illustrates an exemplary image scanned by the scanner 20 shown in FIG. 1.

Illustration (a) of FIG. 2 shows an image formed in the document, and illustration (b) of FIG. 2 shows an image transferred to the computer system 10 after the image shown in illustration (a) of FIG. 2 is scanned. As shown in FIG. 2, illustration (b) of FIG. 2 shows that an image scanned from an area “A” is spaced to the right by a certain distance compared to the original document, which results from a mechanical tolerance occurring upon the production of the scanner, that is, which occurs since each scanner has a different tolerance value. For example, image data for a document scanned by each scanner appears different in position, little by little, due to differences in parts constituting an optical mechanism of the scanner and errors occurring in a process of assembling individual parts.

FIG. 3 schematically illustrates a conventional scanning method for reducing mechanical tolerances, as described in Japanese Patent laid-open No. 14-354207, and corresponds to a cross-sectioned top view of a scanner 20. As the scanner 20 is viewed from over its top, reference numeral 50 denotes a body of the scanner 20, 51 a flatbed for placing a document thereon, 52 an actual scanning area, and 53 a reference mark of the scanner 20. The scanner 50 drives an optical mechanism (not shown) provided in the scanner, when reset, to obtain a compensation value according to a position of the reference mark 53 beyond a valid scanning area, and applies the obtained compensation value when the scanner 20 scans a document. However, such a scanning method fails to compensate for errors occurring during the attaching of the reference mark 53 to the scanner 20, and requires separate devices and processes to accurately attach the reference mark 53, which increases the cost necessary to manufacture scanners. Further, since the reference mark 53 is positioned beyond the valid scanning area, there exists a problem in that it is difficult to accurately compensate for image data obtained from actual scans.

### SUMMARY OF THE INVENTION

Accordingly, it is an aspect and/or advantage of the present invention to provide an image data compensation method for scanners capable of improving scan accuracy at a low cost.

Additional aspects and/or advantages of the invention will be set forth in part in the description which follows and, in part, will be obvious from the description, or may be learned by practice of the invention.

To accomplish the above and/or other aspects and advantages, embodiments of the present invention include To accomplish the above and/or other aspects and advantages, embodiments of the present invention include an image data compensation method for a scanner, compensating a scanned-in image of a medium, connected to a computer system, including scanning a reference medium having a predetermined pattern, obtaining a difference between a coordinate value on the reference medium, detected through the scanning of the reference sheet, and a predetermined reference coordinate value, and calculating a compensation value based on the obtained difference, and applying the calculated compensation value for image data generated when the scanner scans another medium to generate a compensated image data.

The calculating of the compensation value may further include calculating a first distance between a first reference line adjacent to the predetermined pattern and the predetermined pattern, calculating a second distance between a second reference line adjacent to the predetermined pattern and perpendicular to the first reference line and the predetermined pattern, and calculating a difference between the predetermined coordinate reference value and the first and second distances to determine the compensation value.

The calculating of the difference between the predetermined coordinate value and the first and second distances may further include storing the calculated compensation value in a non-volatile memory provided in the scanner.

To accomplish the above and/or other aspects and advantages, embodiments of the present invention further include an image data compensation method for a scanner, sending scanned image data to a computer system having an installed driver program driving the scanner, connected to the computer system, including scanning a predetermined pattern provided on a reference medium, obtaining a difference between a detected coordinate value of the scanned predetermined pattern and a predetermined reference coordinate value, calculating a compensation value based on the obtained difference, and applying the calculated compensation value to the driver program for compensating additional scanned images.

To accomplish the above and/or other aspects and advantages, embodiments of the present invention include a scanner, compensating a scanned-in image of a medium, including a sensor to scan a reference medium having a predetermined pattern, and a controller to obtain a difference between a coordinate value on the reference medium, detected through the scanning of the reference sheet, and a predetermined reference coordinate value, and to calculate a compensation value based on the obtained difference, and to apply the calculated compensation value to image data generated when the scanner scans another medium to generate a compensated image data.

To accomplish the above and/or other aspects and advantages, embodiments of the present invention may still further include a system, compensating a scanned-in image of a medium, including a scanner to scan a reference medium having a predetermined pattern, to obtain a difference between a coordinate value on the reference medium, detected through the scanning of the reference sheet, and a predetermined reference coordinate value, to calculate a compensation value based on the obtained difference, and to apply the calculated compensation value for image data generated when the scanner scans another medium to generate a compensated image data, and a computer to receive data from the scanner for the medium image.

To accomplish the above and/or other aspects and advantages, embodiments of the present invention include a image compensation system for a scanner, sending scanned image data to a computer system having an installed driver program driving the scanner, connected to the computer system, including a scanner to scan a predetermined pattern provided on a reference medium, obtain a difference between a detected coordinate value of the scanned predetermined pattern and a predetermined reference coordinate value, and calculate a compensation value based on the obtained difference, and a computer to apply the calculated compensation value to the driver program for compensating additional scanned images.

Lastly, to accomplish the above and/or other aspects and advantages, embodiments of the present invention include a medium including computer readable code controlling any of the method or system embodiments of the present invention

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 schematically illustrates conventional connections between a computer system and a scanner;

FIG. 2 illustrates an exemplary image scanned by the scanner shown in FIG. 1;

FIG. 3 schematically illustrates a conventional scanning method for reducing mechanical tolerances;

FIGS. 4A and 4B schematically illustrate a concept for a scanning method, according to an embodiment of the present invention;

FIG. 5 is a block diagram illustrating internal structures for a computer system and scanner shown in FIG. 4;

FIG. 6 illustrates an exemplary reference sheet of paper applied to an embodiment of the present invention;

FIG. 7 is a flow chart explaining the image data compensation method for scanners, according to an embodiment of the present invention; and

FIG. 8 is a flow chart explaining an image data compensation method for scanners, according to another embodiment of the present invention.

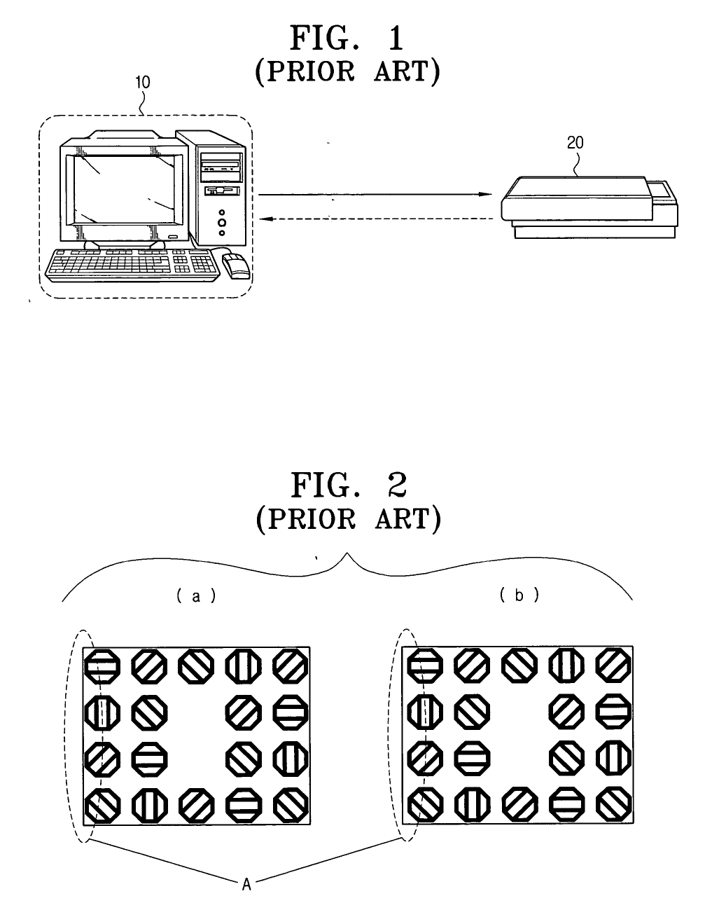

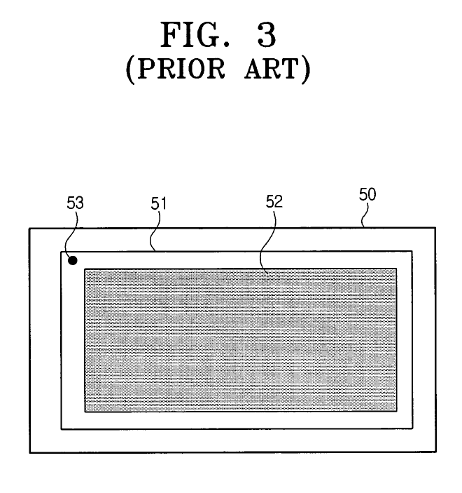

### DETAILED DESCRIPTION OF THE PREFERRED EMBODIMENTS

Reference will now be made in detail to the embodiments of the present invention, examples of which are illustrated in the accompanying drawings, wherein like reference numerals refer to the like elements throughout. The embodiments are described below to explain the present invention by referring to the figures.

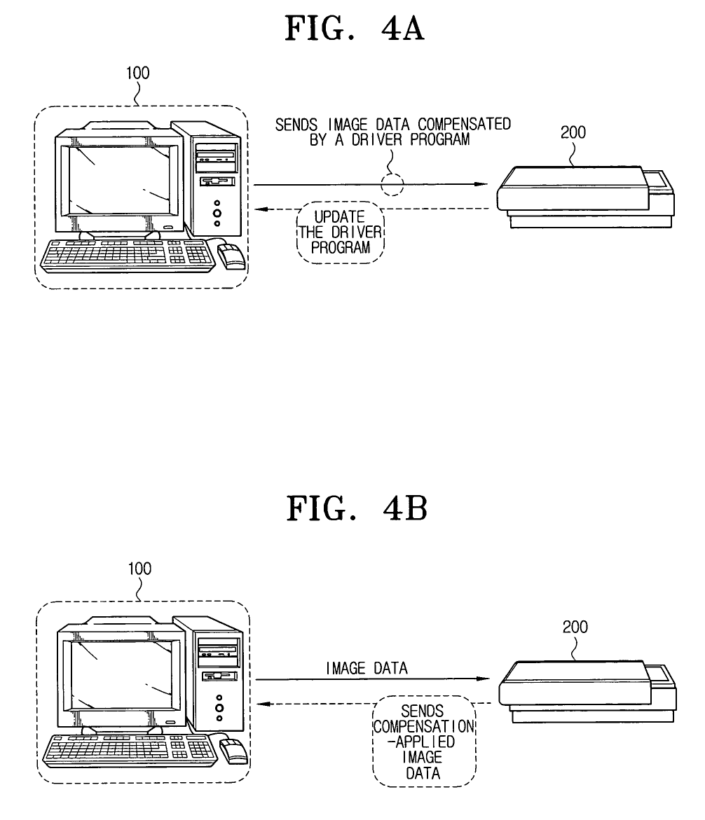

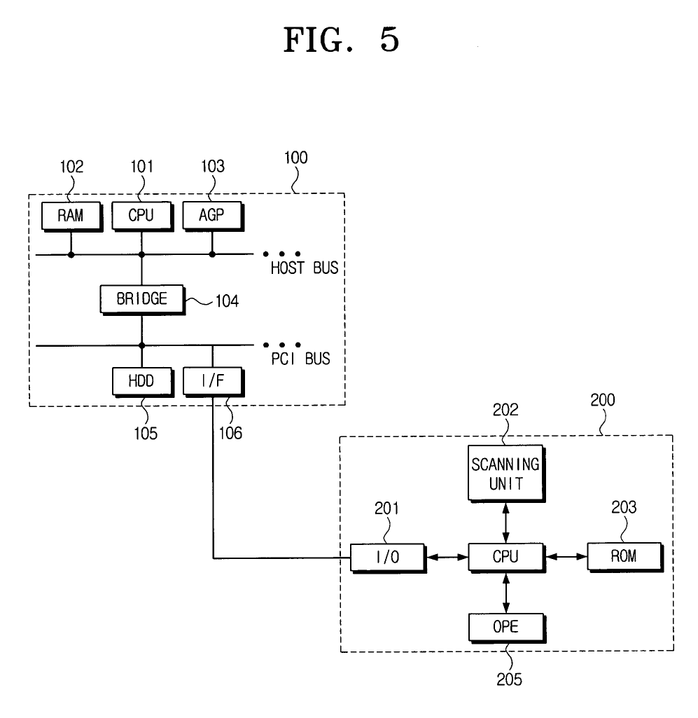

FIGS. 4A-4B schematically illustrate a concept for a scanning method, according to an embodiment of the present invention.

First, FIG. 4A illustrates a concept of a scanner 200 scanning a reference sheet of paper (not shown) having a predetermined pattern, calculating a compensation value based on a result of the scan, sending the calculated compensation value to a scanner driver program (not shown) installed in the computer system 100, and updating the driver program. When driving the scanner 200 with the updated driver program, the computer system 100 can preemptively compensate for coordinate values of a scan area and send the compensated coordinate values to the scanner 200.

Next, FIG. 4B illustrates a concept of the scanner 200 scanning the reference sheet of paper having the predetermined pattern to calculate a compensation value and storing the calculated compensation value in the non-volatile storage medium (not shown) provided in the scanner. When the computer system 100 sends a scanning command to the scanner 200, the scanner 200 sends, to the computer system 100, image data compensated by a pre-stored compensation value.

FIG. 5 is a block diagram illustrating internal structures of the computer system 100 and scanner 200 shown in FIGS. 4A-4B.

The computer system shown in FIG. 5 includes a processor (CPU) 101, a RAM 102, a graphic port (AGP) 103, a bridge 104, a hard disc drive (HDD) 105, and an interface card (I/F) 106. Scanner 200 includes an input/output (I/O) unit 201, a scanning unit 202, a ROM 203, a processor (CPU) 204, and a panel operation (OPE) unit 205.

First, describing the computer system 100, the computer system 100 has the processor (CPU) 101, RAM 102, and graphic port (AGP) unit 103 connected to a high-speed host bus, and the hard disc drive (HDD) 105, interface card (I/F) unit 106, etc., connected to the PCI bus. The host bus and PCI bus are connected through the bridge 104, and the bridge 104 adjusts data transmission timings between the two buses, i.e., the host bus and PCI bus, when data is sent between the high-speed host bus and the low-speed PCI bus.

When a user initiates an application program, the processor (CPU) 101 loads the application program into the RAM 102, and deals with the program initiation according to a process set in the application program. The graphic port (AGP) 103 has a graphic interface card (not shown) mounted to display a result obtained from the process of the processor (CPU) 101 on a display device such as a monitor (also not shown). The hard disc drive (HDD) 105 stores a driver program for driving the scanner 200 and application programs for operating the scanner based on the driver program. Application programs such as Photo Shop™ and Paint Shop™ may be used as the application programs, for editing images, documents, and scanned images. When the application programs require the driving of the scanner 200, a driver program for actually controlling the driving of the scanner 200 can typically be provided by a maker of the scanner 200.

The interface (I/F) unit 106 provides an interface for data communications between the computer system 100 and the scanner 200. The panel operation unit 205 displays the status of the scanner 200 on a display unit, e.g., LuminEscent Diodes (LEDs) or Liquid Crystal Display (LCD), or is provided for user's external controls of the scanner 200.

Next, in view of the scanner 200, the scanner 200 has an input/output (I/O) unit 201 for communicating data with the interface card (I/F) 106, a scanning unit 202 for optically scanning documents, a ROM 203 for storing firmware and/or various setting values employed to drive scanner 200, the panel operation unit 205 for receiving user's external inputs, and a processor (CPU) 204 for controlling overall operations of the scanner 200.

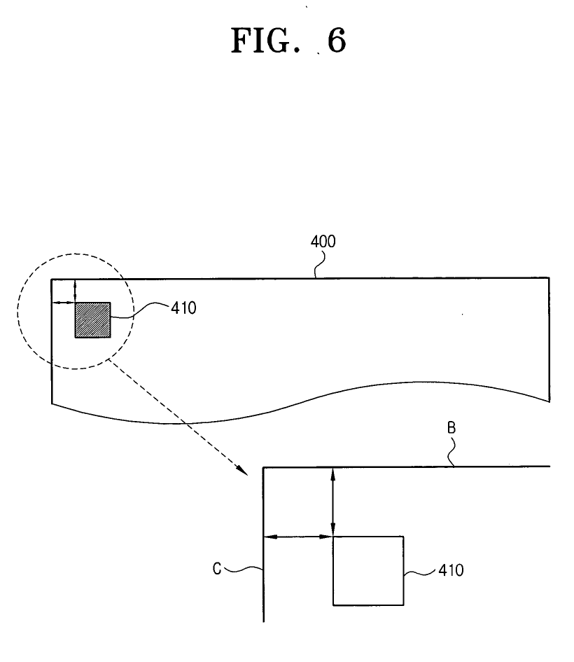

FIG. 6 is a view for showing a reference sheet of paper, and a description, corresponding thereto, will now be made on a method for generating compensation values based on the reference sheet, for an embodiment of the present invention.

Reference numeral 400 denotes the reference sheet, and reference numeral 410 denotes a reference pattern printed on the reference sheet 400. As shown in FIG. 6, the reference sheet 400 is provided with a square reference pattern 410 thereon at a position spaced at a predetermined distance from the upper end line B and the left end line C thereof. A description will now be made under the assumption that x and y coordinates of a start point of the reference pattern 410 are respectively 10 units by 10 units, i.e., 10 units away from the upper end line B and the left end line C of the reference sheet 400.

First, the scanner 200 scans the reference sheet 400 on which the reference pattern 410 is printed. At this time, if a start point of the detected reference pattern 410, that is, if the x and y coordinates of the detected reference pattern 410 (when the scanner 200 scans the reference sheet 400) are 12 and 13, respectively, errors occur by 2 units in the x direction and by 3 units in the y direction. The scanner 200 compares the coordinates of the scanned reference pattern 410 with the predetermined coordinates (10,10), and sends the difference as a compensation value to the computer system 100, to thereby update a driver program stored in the hard disc drive (HDD) 105 or store the compensation value in the ROM 203 provided in the scanner 200. When the compensation value is sent to the computer system 100, the driver program incorporates the sent compensation value to correct the coordinate values for the scanning area, and, when the compensation value is stored in the ROM 205 provided in the scanner 200, the scanner 200 responds to a scanning command from the computer system 100 and incorporates the compensation value stored in the ROM 205 to correct scanned image data, and sends the corrected image data to the computer system 100.

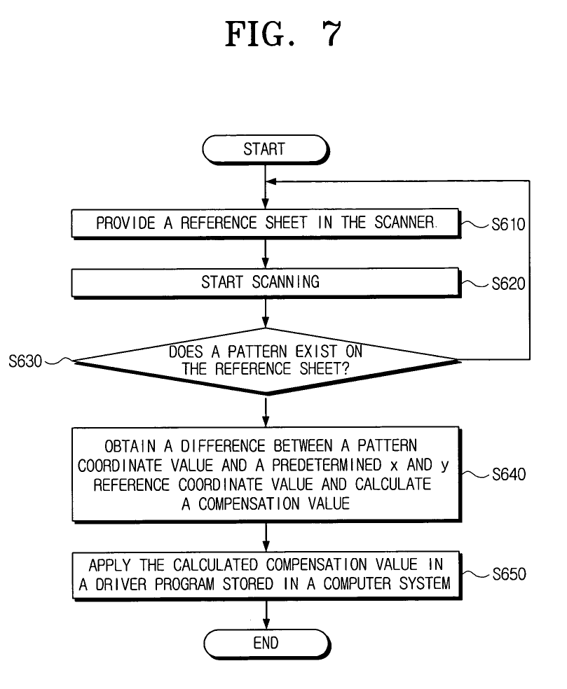

FIG. 7 is a flow chart illustrating an image data compensation method for scanners, according to an embodiment of the present invention.

First, the scanner 200 is provided with a reference sheet (S510). As shown in FIG. 6, the reference sheet has the reference coordinates for the reference pattern 410 spaced in a predetermined distance from the upper end line B and the left end line C of the sheet. Next, the scanner 200 scans the reference sheet 400 (S520), and detects whether the reference pattern 410 exists on the reference sheet 400 (S530). When the reference pattern is detected, the scanner 200 calculates the x and y coordinate value of the reference pattern 410, obtains a difference between the calculated coordinate value and the reference coordinate value stored in the ROM 205, and calculates a compensation value (S540). That is, the calculated compensation value is a difference value between the reference coordinate value and the coordinate value of the scanned reference pattern. Lastly, the calculated compensation value is stored in the ROM 205 provided in the scanner 200 (S550). Thereafter, when a scanning command is applied from an application program, provided in the computer system 100, the scanner 200 scans documents, while applying the compensation value.

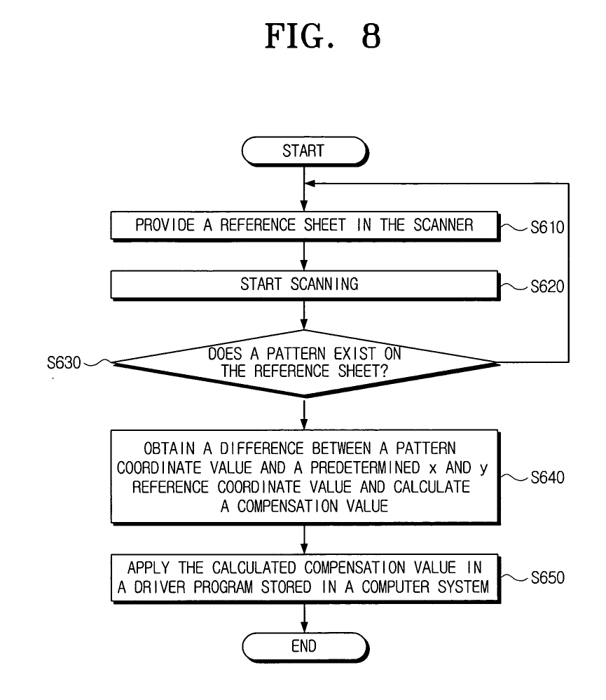

FIG. 8 is a flow chart illustrating an image data compensation method for scanners, according to another embodiment of the present invention.

First, the scanner is provided with a reference sheet (S610). As shown in FIG. 6, the reference sheet has the reference coordinates 410 spaced a predetermined distance from the upper end line B and the left end line C of the sheet. Next, the scanner 200 scans the reference sheet 400 (S620), and detects whether the reference pattern 410 exists on the reference sheet 400 (S630). If the reference pattern 410 exists, the scanner 410 calculates the x and y coordinate value of the reference pattern 410, obtains a difference between the calculated coordinate value and the reference coordinate value stored in the ROM 205, and then calculates a compensation value (S640). Next, the calculated compensation value is sent to the computer system 100, the computer system 100 applies the compensation value to a driver program for driving the scanner 200. The driver program is then updated based on the compensation value applied from the scanner 200. Thereafter, when an application program needs to drive the scanner 200, the driver program applies the compensation value to set a scanning range, and sends the scanning range to the scanner 200. The scanner 200 responds to the sent scanning range and scans a document.

As noted above, embodiments of the present invention can compensate for image data errors due to mechanical tolerances of a scanner when the scanner scans a document. Further, the present invention does not require the attaching of a reference mark by an expensive machine in order to avoid for such errors in conventional scanning, but scans a reference pattern-printed reference sheet in the valid scanning range to thereby obtain an effect of compensating for errors more accurately, compared to the existing scanners. Embodiments of the present invention can include a scanner and/or computer system implementing the present invention. Similarly, the aforementioned driver software/firmware on the scanner and/or computer system can be stored on a medium including computer readable code to control the implementations of the present invention. A medium can include any media capable of providing the computer readable code, e.g., an optical recording disc, storage devices, wired and wireless systems, and wave guides, etc.

Although a few embodiments of the present invention have been shown and described, it would be appreciated by those skilled in the art that changes may be made in these embodiments without departing from the principles and spirit of the invention, the scope of which is defined in the claims and their equivalents.

1. An image data compensation method for a scanner, compensating a scanned-in image of a medium, connected to a computer system, comprising:
scanning a reference medium having a predetermined pattern;
obtaining a difference between a coordinate value on the reference medium, detected through the scanning of the reference sheet, and a predetermined reference coordinate value, and calculating a compensation value based on the obtained difference; and
applying the calculated compensation value for image data generated when the scanner scans another medium to generate a compensated image data.

2. The image data compensation method of claim 1, further comprising sending the compensated image data to the computer system.

3. The image data compensation method of claim 1, further comprising sending the compensation value to the computer system for the generation of the compensated image data.

4. The image data compensation method of claim 1, wherein the calculating of the compensation value further comprises:
calculating a first distance between a first reference line adjacent to the predetermined pattern and the predetermined pattern;
calculating a second distance between a second reference line adjacent to the predetermined pattern and perpendicular to the first reference line and the predetermined pattern; and
calculating a difference between the predetermined coordinate reference value and the first and second distances to determine the compensation value.

5. The image data compensation method of claim 4, wherein the calculating of the difference between the predetermined coordinate value and the first and second distances further comprises storing the calculated compensation value in a non-volatile memory provided in the scanner.

6. The image data compensation method of claim 1, wherein the reference medium is provided with the predetermined pattern being arranged within a range on the medium that the scanner can scan.

7. An image data compensation method for a scanner, sending scanned image data to a computer system having an installed driver program driving the scanner, connected to the computer system, comprising:
scanning a predetermined pattern provided on a reference medium;
obtaining a difference between a detected coordinate value of the scanned predetermined pattern and a predetermined reference coordinate value;
calculating a compensation value based on the obtained difference; and
applying the calculated compensation value to the driver program for compensating additional scanned images.

8. The image data compensation method of claim 7, wherein the calculating of the compensation value further comprises:
calculating a first distance between a first reference line adjacent to the predetermined pattern and the predetermined pattern;
calculating a second distance between a second reference line adjacent to the predetermined pattern and vertical to the first reference line and the predetermined pattern; and
calculating a difference between the predetermined reference coordinate value and the first and second distances to determine the compensation value.

9. The image data compensation method of claim 7, wherein the reference medium is provided with the predetermined pattern being arranged within a range on the medium the scanner can scan.

10. A scanner, compensating a scanned-in image of a medium, comprising:
a sensor to scan a reference medium having a predetermined pattern; and
a controller to obtain a difference between a coordinate value on the reference medium, detected through the scanning of the reference sheet, and a predetermined reference coordinate value, and to calculate a compensation value based on the obtained difference, and to apply the calculated compensation value to image data generated when the scanner scans another medium to generate a compensated image data.

11. A system, compensating a scanned-in image of a medium, comprising:
a scanner to scan a reference medium having a predetermined pattern, to obtain a difference between a coordinate value on the reference medium, detected through the scanning of the reference sheet, and a predetermined reference coordinate value, to calculate a compensation value based on the obtained difference, and to apply the calculated compensation value for image data generated when the scanner scans another medium to generate a compensated image data; and
a computer to receive data from the scanner for the medium image.

12. The system of claim 11, wherein the received data from the receiver is compensated image data.

13. The system of claim 11, wherein the scanner sends the compensation value to the computer system for the application of the calculated compensation value for the image data generated when the scanner scans the other medium to generate the compensated image data.

14. The system of claim 11, wherein the scanner calculating of the compensation value further comprises calculating a first distance between a first reference line adjacent to the predetermined pattern and the predetermined pattern, calculating a second distance between a second reference line adjacent to the predetermined pattern and perpendicular to the first reference line and the predetermined pattern, and calculating a difference between the predetermined coordinate reference value and the first and second distances to determine the compensation value.

15. The system of claim 14, wherein the scanner calculating of the difference between the predetermined coordinate value and the first and second distances further comprises storing the calculated compensation value in a non-volatile memory provided in the scanner.

16. The system of claim 11, wherein the reference medium is provided with the predetermined pattern being arranged within a range on the medium that the scanner can scan.

17. A image compensation system for a scanner, sending scanned image data to a computer system having an installed driver program driving the scanner, connected to the computer system, comprising:
a scanner to scan a predetermined pattern provided on a reference medium, obtain a difference between a detected coordinate value of the scanned predetermined pattern and a predetermined reference coordinate value, and calculate a compensation value based on the obtained difference; and
a computer to apply the calculated compensation value to the driver program for compensating additional scanned images.

18. The system of claim 17, wherein the scanner calculating of the compensation value further comprises calculating a first distance between a first reference line adjacent to the predetermined pattern and the predetermined pattern, calculating a second distance between a second reference line adjacent to the predetermined pattern and vertical to the first reference line and the predetermined pattern, and calculating a difference between the predetermined reference coordinate value and the first and second distances to determine the compensation value.

19. The system of claim 17, wherein the reference medium is provided with the predetermined pattern being arranged within a range on the medium the scanner can scan.

20. A medium comprising computer readable code controlling an implementation of the method of claim 1.

21. A medium comprising computer readable code controlling an implementation of the method of claim 7.
